(19) United States
(12) Patent Application Publication
(10) Pub. No.: US 2022/0198525 A1
(43) Pub. Date: Jun. 23, 2022

(54) ADVERTISING TO A CROWD

(71) Applicant: Show Advertising, Ltd., Caesarea (IL)

(72) Inventors: Shmuel UR, Shorashim (IL); Ori ARDITI, Tel-Aviv Yafo (IL); Ilan PALIOV, Kefar veradim (IL); Shay KARPELES, Ets Efraim (IL)

(21) Appl. No.: 17/645,490

(22) Filed: Dec. 22, 2021

Related U.S. Application Data
(60) Provisional application No. 63/129,606, filed on Dec. 23, 2020.
(60) Provisional application No. 63/129,609, filed on Dec. 23, 2020.

(51) Int. Cl. G06Q 30/02

(52) U.S. Cl. CPC G06Q 30/0275; G06Q 30/0269

(57) ABSTRACT

A method, a computer program product and an apparatus for advertising to a crowd. The method comprises obtaining an estimated aggregated demographic data of an estimated audience of a video configured to be provided to the plurality of members, and performing a crowd-matching between the estimated audience of the video and a campaign to determine a matched campaign. The crowd-matching is performed by an auction between a plurality of participating advertisers, each of which providing a bid for presenting a campaign within the video that defines profile-based compensations. The matched campaign is provided to an audience of the video based on the estimated aggregated demographic data and without performing personalized matching of the matched campaign to a specific member.

### CROSS-REFERENCE TO RELATED APPLICATION

This application claims the benefit of provisional patent application No. 63/129,606 filed Dec. 23, 2020, titled “API AND TECHNOLOGY FOR REPLACING REAL OBJECT WITH A VIRTUAL OBJECT, WHICH MAY BE DIFFERENT OR THE SAME AS THE REAL OBJECT, IN A STREAM”, and provisional patent application No. 63/129,609 filed Dec. 23, 2020, titled “ENABLING ORGANIC ADVERTISING TO THE AUDIENCE OF STREAMERS OF GAMES BY GAME COMPANIES”, which are hereby incorporated by reference in their entirety without giving rise to disavowment.

### TECHNICAL FIELD

The present disclosure relates to organic advertising in general, and to organic advertising in streaming to a crowd, in particular.

### BACKGROUND

Real-time bidding (RTB) is a means by which advertising inventory is bought and sold on a per-impression basis, via instantaneous programmatic auction, similar to financial markets. With RTB, advertisers can bid on an impression and, if the bid is won, the advertiser's ad is instantly displayed on the publisher's site. RTB enables advertisers to manage and optimize ads from multiple ad-networks, create and launch advertising campaigns without talking to a specific content provider, prioritize networks, and the like. On the other hand, RTB enables content providers and publishers to sell advertising locations without searching for advertisers or signing deals with specific advertisers. RTB is essential especially for small publishers, that may not have enough volume to approach directly to advertisers, that otherwise will not be able to sell their advertising inventory.

A popular advertising location is in videos, such is in YouTube™ videos, TV, sport events videos, and the like. Advertising in the form of videos can be attached during or before the video is played, may be part of the video, such as playing at the bottom, embedding an ad in a certain area within the video, and the like. Different models may be used for online advertising, such as impressions, clickthrough and referrals. While impression advertising model is utilized also in TV advertising, clickthrough and referrals may not be possible.

Virtual advertising enables placing a virtual ad on or over a specific element in the video. As an example, in sport events videos, virtual ads may be placed on the grass of the field, on the player's shirt, on the signs in the stadium, or the like. Virtual advertising enables publishers to sell different ads to different markets, such as providing different advertisements for audiences in different locations. In particular, virtual product placement enables placing a product, such as a box of cereal, can of soup, soda bottle, automobile, or the like, into an existing video, such as in a television program, a film, or the like. A product placement can occur after filming, and may be customized for a specific broadcast date, creating a new revenue opportunity for each broadcast.

### BRIEF SUMMARY

One exemplary embodiment of the disclosed subject matter is a method comprising obtaining an estimated aggregated demographic data of an estimated audience of a video, wherein the estimated audience comprises a plurality of members, wherein the video is configured to be provided to the plurality of members. The method further comprises performing a crowd-matching between the estimated audience of the video and a campaign to determine a matched campaign. Said performing crowd-matching comprises: initiating an auction between a plurality of participating advertisers, wherein each advertiser of the plurality of participating advertisers providing a bid for presenting a campaign within the video, wherein the bid is based on the estimated aggregated demographic data and defining at least one profile-based compensation; computing for each bid of the plurality of participating advertisers an estimated compensation based on the estimated aggregated demographic data, wherein the estimated compensation is determined based on a number of estimated members having a demographic profile and based on defined profile-based compensation in the each bid that corresponds to the demographic profile; and selecting a winning bid for the auction based on the estimated compensation. The method further comprises providing an instruction to implement the matched campaign within the video, whereby the matched campaign is provided to an audience of the video based on the estimated aggregated demographic data and without performing personalized matching of the matched campaign to a specific member.

Optionally, the winning bid defining a profile-based compensation for a targeted demographic profile and not defining a profile-based compensation for a non-targeted demographic profile, wherein the estimated compensation is determined based on an estimated number of members in the estimated audience having the targeted demographic profile, wherein the determination of the estimated compensation is indifferent to a number of members in the estimated audience having the non-targeted demographic profile.

Optionally, the winning bid defining a profile-based compensation for a second targeted demographic profile different than the profile-based compensation for the targeted demographic profile, wherein the estimated compensation is determined as C=n₁c₁+n₂ c₂, wherein C denotes the estimated compensation, n₁ denotes an amount of members in the estimated audience having the targeted demographic profile, n₂ denotes an amount of members in the estimated audience having the second targeted demographic profile, c₁ denotes the profile-based compensation for the targeted demographic profile, c₂ denotes the profile-based compensation for the second targeted demographic profile.

Optionally, the participating advertisers comprise a first advertiser and a second advertiser, wherein the first advertiser providing the winning bid, wherein the second advertiser providing a second bid, wherein the second bid defining a profile-based compensation for the non-targeted demographic profile.

Optionally, the method further comprises: automatically validating implementation of the matched campaign in the video.

Optionally, said automatically validating implementation of the matched campaign in the video comprises: analyzing the video to identify a portion of the video in which the matched campaign is implemented.

Optionally, the matched campaign is implemented by a subject appearing in the video performing a non-formally defined action, wherein said analyzing the video comprises identifying the portion of the video in which the subject performs the non-formally defined action.

Optionally, said automatically validating comprises analyzing audience engagement with the matched campaign during providing the video.

Optionally, said analyzing the audience engagement comprises at least one of: analyzing a chat service implemented during providing the video to identify statements made in response to the implementation of the matched campaign; and analyzing user disconnection during the streaming of the video to identify negative user responses to the implementation of the matched campaign.

Optionally, the method further comprising: determining an actual audience of the video; determining aggregated demographic data of the actual audience; computing a compensation based on the winning bid and based on the aggregated demographic data of the actual audience; and providing the computed compensation.

Optionally, a content provider initiating the streaming of the video, wherein the video captures the content provider playing an electronic game, wherein said implementing the matched campaign comprises instructing the electronic game to present the matched campaign.

Optionally, the electronic game is configured in an absence of said instructing to provide a campaign targeting the content provider.

Optionally, the video is streamed by the content provider to the audience via a streaming platform, wherein the electronic game is configured to be played on a gaming platform, wherein the streaming platform and the gaming platform are different.

Optionally, the instruction is provided to a content provider of the video in a predetermined time prior to the video being generated, whereby enabling the content provider to make preparations for implementing the matched campaign within the video.

Optionally, the audience of the video comprises a first and a second members, wherein the video is streamed to the first member at least one hour before the second member, whereby the matched campaign is provided to the first and the second members at different times.

Another exemplary embodiment of the disclosed subject matter is a computerized apparatus having a processor, the processor being adapted to perform the steps of: comprising obtaining an estimated aggregated demographic data of an estimated audience of a video, wherein the estimated audience comprises a plurality of members, wherein the video is configured to be provided to the plurality of members. The steps further comprise performing a crowd-matching between the estimated audience of the video and a campaign to determine a matched campaign. Said performing crowd-matching comprises: initiating an auction between a plurality of participating advertisers, wherein each advertiser of the plurality of participating advertisers providing a bid for presenting a campaign within the video, wherein the bid is based on the estimated aggregated demographic data and defining at least one profile-based compensation; computing for each bid of the plurality of participating advertisers an estimated compensation based on the estimated aggregated demographic data, wherein the estimated compensation is determined based on a number of estimated members having a demographic profile and based on defined profile-based compensation in the each bid that corresponds to the demographic profile; and selecting a winning bid for the auction based on the estimated compensation. The Steps further comprise providing an instruction to implement the matched campaign within the video, whereby the matched campaign is provided to an audience of the video based on the estimated aggregated demographic data and without performing personalized matching of the matched campaign to a specific member.

Yet another exemplary embodiment of the disclosed subject matter is a computer program product comprising a non-transitory computer readable storage medium retaining program instructions, which program instructions when read by a processor, cause the processor to perform a method comprising: comprising obtaining an estimated aggregated demographic data of an estimated audience of a video, wherein the estimated audience comprises a plurality of members, wherein the video is configured to be provided to the plurality of members. The method further comprises performing a crowd-matching between the estimated audience of the video and a campaign to determine a matched campaign. Said performing crowd-matching comprises: initiating an auction between a plurality of participating advertisers, wherein each advertiser of the plurality of participating advertisers providing a bid for presenting a campaign within the video, wherein the bid is based on the estimated aggregated demographic data and defining at least one profile-based compensation; computing for each bid of the plurality of participating advertisers an estimated compensation based on the estimated aggregated demographic data, wherein the estimated compensation is determined based on a number of estimated members having a demographic profile and based on defined profile-based compensation in the each bid that corresponds to the demographic profile; and selecting a winning bid for the auction based on the estimated compensation. The method further comprises providing an instruction to implement the matched campaign within the video, whereby the matched campaign is provided to an audience of the video based on the estimated aggregated demographic data and without performing personalized matching of the matched campaign to a specific member.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A-1D show flowchart diagrams of methods, in accordance with some exemplary embodiments of the disclosed subject matter;

FIG. 2 shows a block diagram of an apparatus, in accordance with some exemplary embodiments of the disclosed subject matter;

FIG. 3 shows a schematic illustration of an exemplary implementation, in accordance with some exemplary embodiments of the disclosed subject matter; and

FIGS. 4A-4F show flowchart diagrams of methods, in accordance with some exemplary embodiments of the disclosed subject matter.

### DETAILED DESCRIPTION

One technical problem dealt with by the disclosed subject matter is enabling an organic advertising for one-to-many videos.

In some exemplary embodiments, the videos may be real-time videos streamed by on content provider to a plurality of content consumers, such as a social media influencer live streaming to a global audience, audience of followers, or the like. Additionally or alternatively, the video may be viewed in different timing by different portion of the audience. In some exemplary embodiments, content providers may publish their videos in online platforms such as Twitch™, Instagram™, YouTube™, Snapchat™, Twitter™, Facebook™, VSCO™, Reddit™, WeChat™ QQ™ TikTok™, or the like. Some videos may be generated off-line and published in a relevant platform, such as YouTube™ videos. Additionally or alternatively, some videos may be broadcasted in real-time, such as live videos in social networks, or the like. Some videos may be available for the audience after the real-time streaming is finished, may be unavailable directly after the streaming ends, may be accessible for a predetermined time frame, such as for the next 24 hours, the next week, or the like.

In some exemplary embodiments, such content providers may function as influencers, lifestyle gurus who promote a particular lifestyle or attitude, multiply trends, such as in fashion, beauty, cooking, technology, video games, e-sports, politics, music, sports, entertainment, or the like. The content providers may be recruited by companies for influencer marketing to advertise products to their fans and followers on their platforms. Selecting a relevant campaign to be suitable for promotion by the content provider may be challenging, as the crowd may be varying, may be different than the content provider herself, may not be targeted to all portions of the crowd, or the like. As an examples, a large chunk of followers of female models may be middle age men, teenage females may be among the crowd of male football players, or the like. In some cases, it may be more profitable that the content provider advertises or promotes a campaign that may not be directly targeted to a crowd having similar features, demographic data, interests, or the like, to the content provider herself or to the lifestyle formally provided by the content provider. Referring to the previous example, against a naturally predicted choice, a male football player may promote female targeted campaigns.

Another technical problem dealt with by the disclosed subject matter is adapting RTB models for one-to-many live-streaming videos. In some exemplary embodiments, RTB enables a trade of physical advertising inventory, which may be bought and sold on a per-impression basis. The advertisers may bid on an impression ad and the ad of the winning bid may be instantly displayed on the publisher's site. In some exemplary embodiments, the campaign promoted by content providers in real videos may not be a computationally added element in a certain location or timing, such as regular advertising spot or location, viewing an ad over the video, or the like. Additionally or alternatively, RTB may be based on user's demographic information, browsing history, location, the page being loaded, shopping habits, salary, political leaning, number of kids, loads, or the like. The information may be collected on people and traded between companies and websites. However, such information may not be directly available in the case of one-to-many live-streaming videos, as the audience of such videos may not identified by the streaming platforms, as the members of the audience only see the stream, and the available information the streaming platform may have access thereto may be, at best, an internal identifier, such as a handle number, or the like.

Yet another technical problem dealt with by the disclosed subject matter is validating that a campaign has been implemented by the content provider in a live-streamed video. In some exemplary embodiments, promotion of the campaign in real-time videos may not be automatically tracked like in regular organic advertisement. In some exemplary embodiments, the implementation of the campaign may be by an action performed by the content provider within the video, such as by an audio description, verbally mentioning an item, physically viewing a product, such as by holding, wearing, using, or the like, presenting the product on a means within the video, such on a screen, on a board, or the like. Tracking and validating of such implementation may be challenging and may require an additional action from the advertiser, more resources, or the like.

Yet another technical problem dealt with by the disclosed subject matter is enabling an efficient virtual advertising in live-streamed video games. Live streaming of video games may be an activity where people broadcast themselves playing games to a live audience online. Live streaming of video games may be provided in designated websites or platforms, such as in Twitch™, YouTube™, Facebook™, Huya-Live™, DouYu™, Bilibili™, or the like. It may be desired that professional streamers can combine utilize their high-level play and entertaining commentary, to earn income from sponsors, subscriptions, donations, or the like.

Yet another technical problem dealt with by the disclosed subject matter is enabling a correlation between the game instance that the gamer is playing in a computer game, and the streaming of that same game in a stream, and reducing the time required for performing the correlation.

In some exemplary embodiments, unlike regular RTB, where publishers or content providers can directly offer advertising locations for potential advertisers, a more complicated correlation may be required for generating an RTB model for live-streamed video games. In some exemplary embodiments, the information required for generating such a model may not be provided by a single party, may not be shareable, or the like. As an example, the gaming company may have information about the gamer, such as her location, gaming habits, or the like, potential advertising locations in the game, or the like; while the streaming platform may have information about the audience, such as the size of the audience, demographical data, or the like. Both types of information may be required to be analyzed and combined in order to determine elements of the RTB model, such as the revenue of the advertisement, adapting the advertiser according to the target audience, adapting the gamer to the advertised product, or the like, in addition to other technical elements, such as a potential advertising location, timing, or the like.

Yet another technical problem dealt with by the disclosed subject matter is connecting between game companies and potential streamers. As an example, a video game streamer plays a Grant Theft Auto (GTATM™) game, and streams the game in live. The game company, GTATM™, knows the streamer only as a gamer (e.g., a player of GTATM™) that sees in-game advertising for which the gaming company gets paid. Information about the streamer, as a gamer, may be known to the game company, such as an internal identifier of the gamer, such the name used by the gamer in the game (e.g., Shmuel57), location of the gamer, amount of money spent by the gamer in the gaming platform, gaming interaction and habits of the gamer, any information provided by the gamer, or the like. The game company may utilize the information about the gamer to decide on ads to be shown to the gamer in the game. Advertisers may bid and the advertisement may be placed in the game, by the gaming company.

One technical solution is to determine a matched campaign to be implemented in the video based on an estimated aggregated demographic data of potential audience of the video, without performing personalized matching of the matched campaign to a specific member of the audience of the video.

In some exemplary embodiments, the potential audience may comprise a plurality of members which the video is simultaneously streamed thereto by the content provider. The video may be configured to be streamed by the content provider to the plurality of members via a streaming platform. A crowd-matching may be performed between the potential audience and potential campaigns to determine the matched campaign. In some exemplary embodiments, an auction between a plurality of participating advertisers may be performed based on estimated aggregated demographic data of the potential audience.

Each participating advertiser may provide a bid for presenting a campaign within the video based on the estimated aggregated demographic data. Each bid may define at least one profile-based compensation, such as an example, 1 cent to each female member. An estimated compensation for the content provider may be computed for each bid based on the estimated aggregated demographic data. The estimated compensation may be determined based on a number of estimated members having a demographic profile and based on defined profile-based compensation in each bid that corresponds to the demographic profile. As an example, the estimated compensation may be 1 (e.g., the defined profile-based compensation for female members) multiplied by the estimated number of female members within the potential audience. A winning bid for the auction may be selected based on the highest estimated compensation.

In some exemplary embodiments, the winning bid may define different compensations for different demographic profiles of members of the audience. As an example, the winning bid may define a first compensation for members in the age of 20-30 and a second compensation for members of age above 30. Additionally or alternatively, the winning bid may not define a compensation for non-targeted demographic profiles. As an example, the winning bid may not provide any compensation for members below 20 years old, for members located outside France, or the like. The estimated compensation for the content provider may be determined based on an estimated number of members in the audience having a targeted demographic profile and may be indifferent to a number of members in the audience which the matched campaign is not targeted thereto and no compensation is defined thereto. It may be noted that different advertisers may provide different types of compensations, such as defining different types of profile-based compensations, targeting different demographic profiles, or the like.

Another technical solution is to automatically validate implementation of the matched campaign in the video during or after streaming thereof. In some exemplary embodiments, the video may be analyzed to identify a portion thereof in which the campaign is implemented. In some exemplary embodiments, the campaign may be implemented by a subject appearing in the video performing a non-formally defined action, such as verbally promoting the campaign, wearing clothes promoting the campaign, viewing an object related to the campaign, or the like. The analysis may comprise identifying performance of the non-formally defined action by the subject. Additionally or alternatively, the automatic validation may be based on analysis of the audience engagement with the matched campaign during streaming of the video, such as analyzing a chat service implemented during the streaming of the video to identify statements made in response to the implementation of the matched campaign, analyzing user disconnection during the streaming of the video to identify negative user responses to the implementation of the matched campaign, or the like.

In some exemplary embodiments, the video may capture the content provider playing an electronic game. implementation of the matched campaign may be by instructing the electronic game to present the matched campaign. The electronic game may be played on a gaming platform different than the streaming platform utilized by the content provider to stream the video. It may be noted that the electronic game may be configured in an absence of implementation of the matched campaign, to provide a campaign targeting the content provider herself.

Yet another technical solution is compute a compensation for the content provider based on an analysis of the actual audience of the video and aggregated demographic data of such actual audience. In some exemplary embodiments, the compensation may be computed based on the winning bid and based on the aggregated demographic data of the actual audience.

Yet another technical solution is utilizing live-streamed games for advertising. In some exemplary embodiments, gamers may be paid for endorsements or advertising, by showing a product while they stream their game, such as holding the product, wearing the product, using the product, talking about the product, or the like. A value of the endorsement may be touted in order to calculate the revenue for the gamer. The advertising may be provided by the gamer to the audience of the gamer in the streaming platform. In a case of live streaming of the game, different parties may be involved, such as the gaming company (e.g., the game instance), the streaming provider, the gamer and the potential advertisers. It may be desirable to be able to choose the advertisement based on knowledge that the game is being watched by other people, an audience, and any information on said audience. Publishers, content providers or any IP owners related to such gaming industry can maximize the value of their content by providing the content via designated marketplace, where that content being mapped for dozens and hundreds of product placement opportunities and be layered with restrictions that comply with creative needs. Such opportunities may be ranked and priced by their effectiveness to drive marketing goals for brands. Brands can bid on in-video placement opportunities that fit their marketing strategies and budgets. 3D brand assets can be uploaded and inserted dynamically into content right before the moment of video delivery.

In some exemplary embodiments, the gamer may play a computer game over the internet. The gaming company, on which servers the game is being played, may embed advertisements in the computer game such that the advertisements are visible to the gamer. In such a case, the game company is the content provider in the terms of RTB, and the gamer is the target audience of the advertisements. Thus, the choice of the advertisement may depend on properties of the gamer that are available to the game company, such as a language choice, demographic related targeting, or any other aspects of the advertiser. It may be noted that in many cases, the game company may not even be aware of the streaming. Additionally or alternatively, even if the game company is aware to the streaming, the game company may not have any information about who, beside the gamer, is watching the game.

In some exemplary embodiments, the streaming platform on which the game is being broadcast to an audience may be unrelated, technically, to the game instance being played, neither to the game company, or the like. The streaming platform may be configured to stream the content of the screen of the gamer or the player to the audience, without relating to the content or the game company. On the other hand, the game company may not know anything on the size, or attributes of the audience, and may even not know if that the game is being streamed at all and if such an audience exists.

Yet another technical solution is to perform a dynamic correlation between a game instance being played and a stream instance being broadcast dynamically as the game is being played. Performing a dynamic correlation while the game is being played and streams, and not in retrospect, enables informing the game company about the streaming and the audience, thereby enabling to select the correct advertisements, that targets the audience in addition to the gamer. If the correlation is performed in retrospect, such as a day later, the content of the game may no longer be modified by the game company as the game had already been played, and only a recording may now exist, which is not under the control of the gaming company. In some exemplary embodiments, the gamer, who is also a streamer, may not be directly involved in establishing such correlation.

In some exemplary embodiments, in order to perform the correlation, it may be required to automatically identify that a gamer is streaming. Streamers that stream specific games may be identified in real time, such as by searching relevant streaming platforms (e.g., platforms the type of the game the streamer is playing is usually published, designated platforms, or the like). When a stream is found, it may be observed to determine a unique marking in it embedded by the game company. Such unique marking could be a unique bar code embedded in the game instance by the game company or any other distinguishing mark. As an example, the unique marking may be a user name in the game that may appear on the screen. The unique marking may be utilized to identify the gamer, such as via the gaming company. This establishes a correlation between the game instance and the stream instance.

In some exemplary embodiments, the streamer, who is also a gamer, may have incentive to help with the correlation. The streamer may provide information known to him, such as a user name, a session ID of a game, a server name, an IP address, starting time of game, or the like, to one of the entities performing the correlation between the game instance and the stream instance, such as the stream instance, the gaming company, the advertising hub, or the like. The information provided by the streamer may be utilized to establish the correlation, enrich the correlation, or the like.

In some exemplary embodiments, a designated identification software may be installed on the gamer/streamer platform. The designated identification software may be configured to collect identifying information of the streamer that may be related to the gaming or the streaming, such as IP address, session ID of game, exact time of game starting, any information from the gaming company, or the like. Additionally or alternatively, the streamer herself may record in the designated identification software, identifying information thereof, such as her user name in specific games or any other identifying information that can be used to identify a game instance. When the streamer starts streaming, the designated identification software may communicate any information it has recorded and submit this information to the relevant entity, such as the gaming company, the advertising hub, or the like, that may utilize the information to correlate the game instance to the streaming instance.

In some exemplary embodiments, the correlation may be performed by one or more sides thereof, such as the gaming company, the advertising company, the streaming platform, or the like. Additionally or alternatively, the correlation may be performed by an external entity that is connected to each of the correlated sides.

In some exemplary embodiments, the entity that establish the correlation may be an advertising hub. The advertising hub may be configured to select one or more advertisement to be integrated in the streamed game, and submit the one or more advertisement to the game company for inclusion in the identified game instance. The selection of the one or more advertisement may depend on the estimated properties of the audience and of the gamer, properties of the stream, or the like. Additionally or alternatively, the advertising hub may be configured to determine the payment to be paid to the streamer. The payment may depend on the property of the audience measured when the advertisement is shared in the streaming instance, such as the size of the audience, an interaction of the audience with the stream, or the like.

Additionally or alternatively, the entity that establish the correlation may be the game company. In this case, the game company may become aware of the audience of the game. The game company may choose the advertising itself, based on the audience, or transact with an advertising hub for an advertising, while revealing the audience to the advertising hub so that the appropriate advertisement can be selected.

In some exemplary embodiments, the entity that establish the correlation is streaming platform (e.g., application, website, or the like) used by the streamer. The streaming platform may be configured to selects one or more advertisement, and submit the one or more advertisement to the game company for inclusion in the identified game instance. The selection of the one or more advertisement may depend on the estimated properties of the audience and of the gamer and other properties of the stream. The payment may depend on the property of the audience measured when the advertisement is shared in the streaming instance. It may be preferable to advertise in the game being played as this requires less screen location, and may be less intrusive, than advertising in the streaming platform itself.

In some exemplary embodiments, it is desirable that a person from the audience of the stream will be able to choose a game effect. A game effect may include an advertisement such as “Daniel, will you marry me”, a background song, a choice of game opponent, or any other in game effect. In such a case the person in the audience communicates, either in the stream, or to an entity that is known as watching the stream such as the advertising hum, her request. If it is in the stream, in some exemplary embodiment the crawler that is watching the stream identify the request, processes it, and may forward it to the gaming company. In some exemplary embodiment the streaming platform itself has means for the audience to communicate with it, such as a commands available in the platform. In some exemplary embodiment, a dedicated software is used by an audience member to enhance the streaming application with capabilities that include communication options for requests of game effects. In some exemplary embodiment, the request includes identifier of the stream, and the entity (advertising hub, gaming company communication channel, or any other) may forwards it to the game company, by the audience member for processing. The request than can be used to impact the game being watched by the streamer.

One technical effect of utilizing the disclosed subject matter is enabling targeting campaigns in one-to-many videos, without performing personalized matching of the matched campaign to a specific member of the members watching the video, while increasing the potential compensation for the content provider and enabling a more successful campaign for the advertiser.

Another technical effect of utilizing the disclosed subject matter is enabling performing auctions in a short time (e.g., few seconds, less than a minute, less than an hour, or the like), such as RTB for advertising in one-to-many live-streaming videos, without a priori knowledge of an exact advertising slot, or having exact demographic data of a certain user.

Yet another technical effect of utilizing the disclosed subject matter is enabling an efficient automatic validation of non-typical implementation of campaigns in one-to-many videos.

Yet another technical effect of utilizing the disclosed subject matter is enabling an efficient virtual advertising in live-streamed video games. The disclosed subject matter enables providing targeted campaigns to the gamer herself besides campaigns targeted to the audience of the gamer when streaming a video associated with the game.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

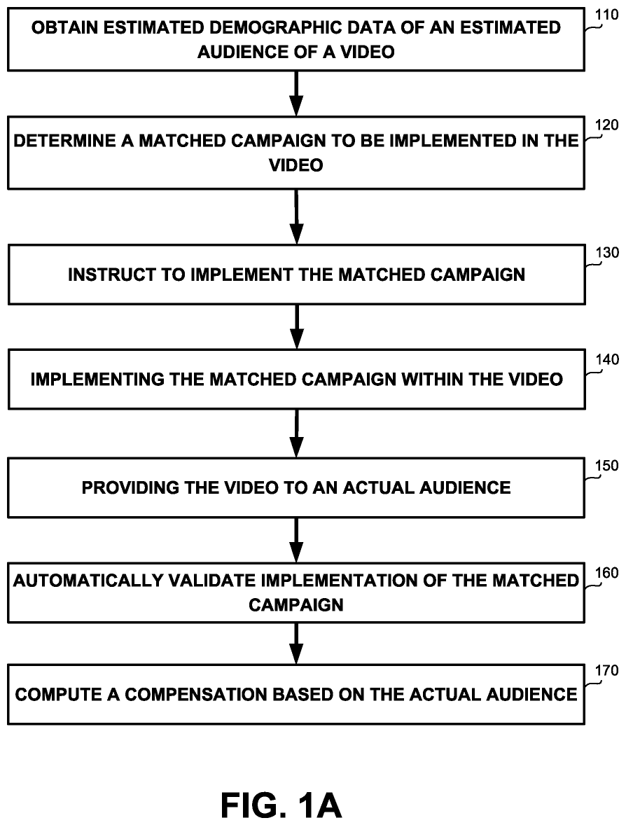

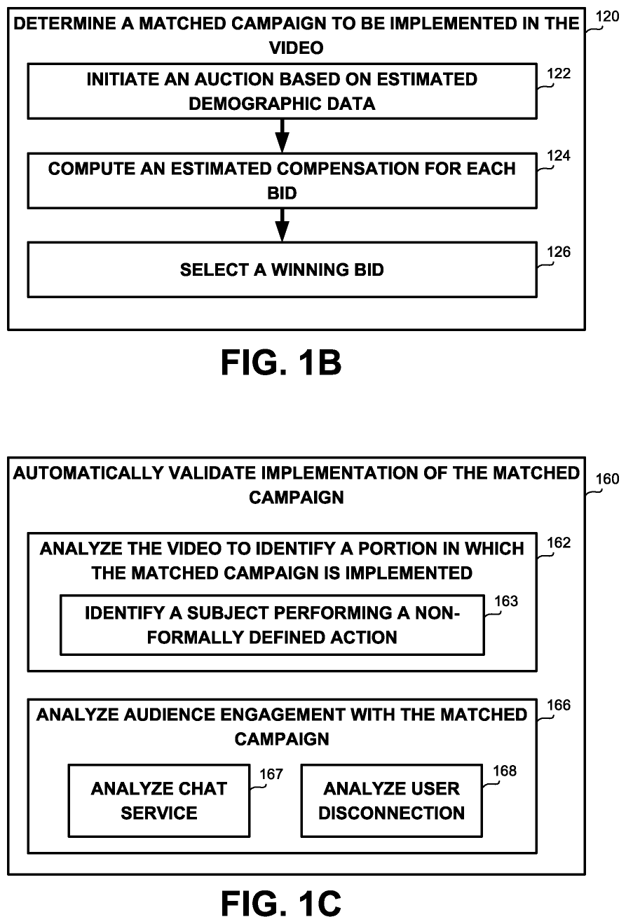

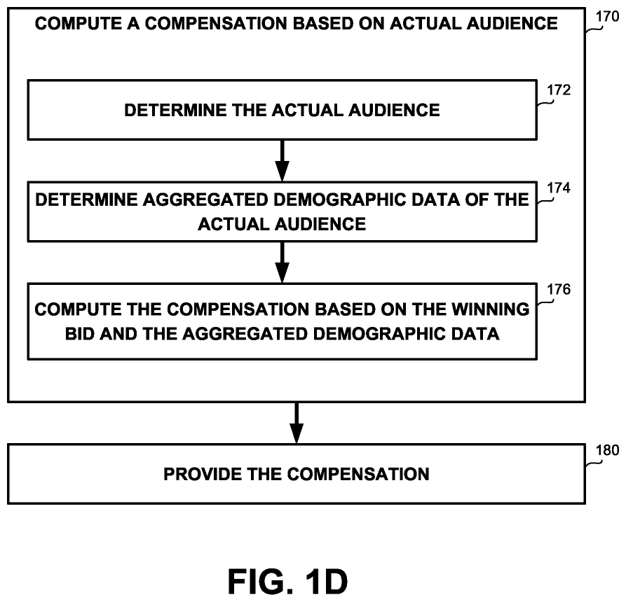

Referring now to FIG. 1A showing a flowchart diagram of a method, in accordance with some exemplary embodiments of the disclosed subject matter.

On Step 110, an estimated aggregated demographic data of an estimated audience of a video may be obtained.

In some exemplary embodiments, the video may be configured to be generated by a content provider, such as an electronic game player, a social media influencer, or the like. The video may be configured to be streamed by the content provider to the plurality of members via a streaming platform, such as Twitch™, Instagram™, YouTube™, Snapchat™, Twitter™, Facebook™, VSCO™, Reddit™, WeChat™, QQ™, TikTok™, or the like.

In some exemplary embodiments, the estimated audience may comprise a plurality of members which the video is simultaneously streamed thereto by the content provider, the streaming platform, or the like. Additionally or alternatively, the video may be configured to be provided for different members of the estimated audience separately, via different streaming platforms, in different timings, or the like.

In some exemplary embodiments, the estimated audience may be predicted based on content of the video, based on global or local trends of videos or contents, based on audiences of previous videos provided by the same or similar content providers, based on historical data of videos streamed in the same or similar streaming platforms, or the like. The estimated aggregated data may be determined based on information provided by the streaming platform, data obtained based on monitored communication with the streaming platform, data of audience of similar videos, or the like.

On Step 120, a matched campaign to be implemented within the video may be determined. In some exemplary embodiments, the matched campaign may be determined based on a crowd-matching between the estimated audience of the video and potential campaigns, such as using an adapted auction, an RTB model, or other types of auctions. In some exemplary embodiments, Step 120 may be performed using the method shown in FIG. 1B.

On Step 130, an instruction to implement the matched campaign within the video may be provided. The instruction may be provided to the streaming platform, to the content provider of the video, to a subject appearing in the video, to an entity associated with an element of the video, or the like.

In some exemplary embodiments, the instruction may comprise a specific instruction for performing a specific action, for vocalizing a specific text, utilizing a certain object, or the like. As an example, the instruction may be instructing the content provider to wear a certain outfit associated with the matched campaign, to hold a certain object (such as a product provided by the advertiser), or the like. Additionally or alternatively, the instruction may comprise a non-defined action to be performed by the content provider, such as “doing something” with the campaign, saying positive comment on a product or a service of the advertiser or the matched campaign, or the like.

Additionally or alternatively, the instruction may comprise instructing the streaming platform, the gaming platform, a combination thereof, or the like, to perform an object placement within the video, to present a certain element within the video, or the like.

In some exemplary embodiments, one or more of Steps 110-130 may be performed offline, prior to generating the video (such as few hours before, few minutes before, or the like), in response to a trigger obtained from the content provider, such as a statement in social network indicating that the video is about to be streamed in a certain timing, or the like. Additionally or alternatively, Steps 110-130 may be performed simultaneously, in real time, or the like, with streaming the video.

Additionally or alternatively, Step 130 may be performed in a predetermined time prior to the video being generated, such as about 10 minutes, about an hour, or the like; thereby enabling the content provider to make preparations for implementing the matched campaign within the video.

On Step 140, the matched campaign may be implemented within the video, such as by the content provider, by the gaming platform, or the like.

On Step 150, the video may be transmitted to an actual audience, such as via a streaming platform, or the like.

On Step 160, implementation of the matched campaign within the video may be automatically validated. In some exemplary embodiments, Step 160 may be performed using the method shown in FIG. 1C.

On Step 170, a compensation may be computed based on an actual audience of the video. In some exemplary embodiments, Step 170 may be performed using the method shown in FIG. 1D.

Referring now to FIG. 1B showing a flowchart diagram of a method, in accordance with some exemplary embodiments of the disclosed subject matter.

In some exemplary embodiments, the matched campaign may be configured to be provided to an audience of the video based on the estimated aggregated demographic data of the estimated audience, and without performing personalized matching of the matched campaign to a specific member of the audience. The matched campaign may be targeted to only a portion of the estimated audience.

On Step 122, an auction between a plurality of participating advertisers may be initiated. Each advertiser of the plurality of participating advertisers may be enabled to provide a bid for presenting a campaign within the video. Each bid may be based on the estimated aggregated demographic data. Each bid may define at least one profile-based compensation.

In some exemplary embodiments, the auction may be an RTB auction. RTB auctions may be concluded in few centiseconds, such as about 1/20 of a second, or the like. Additionally or alternatively, the auction may be performed a predetermined time prior to the expected time of implementing the campaign, such as about 1 second, about 5 seconds, less than a minute, or the like.

In some exemplary embodiments, each bid may be defining one or more profile-based compensation for one or more targeted demographic profile, a profile-based compensation for a non-targeted demographic profile, or the like. The estimated compensation may be determined based on an estimated number of members in the estimated audience having the one or targeted demographic profile. The estimated compensation may be indifferent to a number of members in the estimated audience having the non-targeted demographic profile. As an example, a bid of a first advertiser may define a first compensation of X dollars for a first targeted profile of {female members, located in the USA}, a second compensation of Y dollars for a second targeted profile of {female members, located in Europe} and a third compensation of Z dollars for a third targeted profile of {female members, located in Asia}. The estimated audience may comprise members not belonging to any of the targeted profiles, e.g., male members, female members not from the USA, Europe or Asia). Such members may be associated with non-targeted profiles and may not be taken into account in the estimated compensation, despite the matched campaign being provided thereto.

In some exemplary embodiments, different participating advertisers may provide different bids, with different targeted members, with different categorizations of profiles, or the like. As an example, a bid of a second advertiser may define a first compensation of X2 dollars for a first targeted profile of {female members, located in the USA} and a second compensation of Y2 dollars for a second targeted profile of {female members, located in Europe}, without defining any compensation for the third targeted profile of {female members, located in Asia} or other non-targeted profiles. As another example, a bid of a third advertiser may define a first compensation of X3 Euros for a first targeted profile of {members above 30 years old} and a second compensation of Y2 Euros for a second targeted profile of {members between 20 and 30 years old}. The second bid may or may not define a compensation for non-targeted profiles, e.g., {members below 20 years old}, may define a negative compensation for such profiles, or the like.

In some exemplary embodiments, the estimated compensation may be determined as C=Σnᵢcᵤ wherein C denotes the estimated compensation, nᵢ denotes an amount of members in the estimated audience having the i^{th} targeted demographic profile, and cᵢ denotes the profile-based compensation for the i^{th} targeted demographic profile.

Referring to the above-mentioned example, the estimated compensation of the bid of the first advertiser may be C=X·(the number of female members located in the USA)+Y·(the number of female members located in Europe)+Z·(the number of female members located in Asia).

On Step 124, an estimated compensation for each bid of the plurality of participating advertisers may be computed based on the estimated aggregated demographic data. The estimated compensation may be determined based on a number of estimated members having a demographic profile and based on defined profile-based compensation in the bid that corresponds to the demographic profile.

On Step 126, a winning bid for the auction may be selected based on the estimated compensation.

In some exemplary embodiments, the winning bid may be defining a one or more profile-based compensations for a one or more targeted demographic profiles and not defining a profile-based compensation for a non-targeted demographic profile. Accordingly, the estimated compensation (e.g., the compensation estimated to be provided to the content provider, to the streaming platform, to a gaming platform, or the like), may depend on a portion of the estimated audience that matches one or more of the targeted demographic profiles. The winning bid may be selected based on a bid providing a highest total estimated compensation, a highest estimated compensation for the content provider, a highest estimated compensation for the streaming platform, a highest estimated compensation for the gaming platform, a combination thereof, or the like.

Referring now to FIG. 1C showing a flowchart diagram of a method, in accordance with some exemplary embodiments of the disclosed subject matter.

On Step 160, the video may be analyzed to identify a portion of the video in which the campaign is implemented. As an example, the campaign may be implemented in the end of the video, at the beginning of the campaign, or the like. As another example, the campaign may be implemented at a certain time-frame within the video, or the like. As yet another example, the campaign may be implemented in a certain location within the video, such as at the bottom of the video, in a popping window, or the like.

In some exemplary embodiments, the campaign may be implemented by a subject appearing in the video performing a non-formally defined action. In some exemplary embodiments, the non-formally defined action may be presenting an object related to the campaign, such as a background item, or the like. Additionally or alternatively, the non-formally defined action may be a verbal action, such as saying something (pre-defined, spontaneous, a combination thereof, or the like), talking about the campaign, endorsing the matched campaign by a speech, or the like. Additionally or alternatively, the non-formally defined action may be an action performed on an object related to the matched campaign, such as holding the object, using the object to perform another action (such as playing an instrument, using a gaming tool, or the like), placing the object, performing a natural action related to the object (such as wearing an object, drinking using the object, playing with the object, or the like), or the like.

On Step 163, the portion of the video in which the subject performs the non-formally defined action may be identified to validate implementation of the matched campaign. In some exemplary embodiments, the portion may be automatically identified, such as using image analysis techniques, identifying a marker or a barcode, sound analysis, a designated application, a web bot, or the like. Additionally or alternatively, the portion or the non-formally defined action may be identified manually, by an actual member of the audience, or the like.

On Step 166, an audience engagement with the matched campaign during providing the video may be analyzed.

In some exemplary embodiments, validation of the implementation of the video may be performed based on an analysis of the audience engagement with the matched campaign, such as reacting to the campaign, clicking on a Like button in the streaming platform, expressing support or other reaction, writing a reply text, favoring, or the like.

Additionally or alternatively, the audience engagement with the matched campaign may be determined based on a quantitative measurement obtained from the streaming platform, such as the number of members in the audience, a number of members voting in favor, (such as by “Like”, “Favorite”, “retweet”, or the like), against (such as by “dislike”, or the like), or neutrally, a review score, a wider range of emotion to the content, or the like.

On Step 167, a chat service implemented during providing the video may be analyzed to identify statements made in response to the implementation of the matched campaign, such as identifying words related to the campaign, identifying marks within the chat in response to the campaign, or the like.

On Step 168, a user disconnection during the streaming of the video may be analyzed to identify negative user responses to the implementation of the matched campaign.

Referring now to FIG. 1D showing a flowchart diagram of a method, in accordance with some exemplary embodiments of the disclosed subject matter.

On Step 172, the actual audience of the video may be determined, such as based on data obtained from the streaming platform, based on analysis of the video, or the like.

On Step 174, aggregated demographic data of the actual audience of the video may be determined. The aggregated demographic data may be obtained from designated databases, such as databases storing demographic data of usernames in a certain platform, database of the streaming platform, crossbreeding with the estimated aggregated data of the estimated audience, or the like.

On Step 176, the compensation may be computed based on the winning bid and based on the aggregated demographic data of the actual audience. As an example, the compensation may be based on the above exampled bid of the first advertiser based on the number of female members in the actual audience from each area.

On Step 180, the compensation may be provided to the relevant parties related to the implementation of the matched campaign. In some exemplary embodiments, the compensation may be provided to the content provider. Additionally or alternatively, the compensation may be provided to the streaming platform, the gaming platform, any other entity associated with the video, or the like.

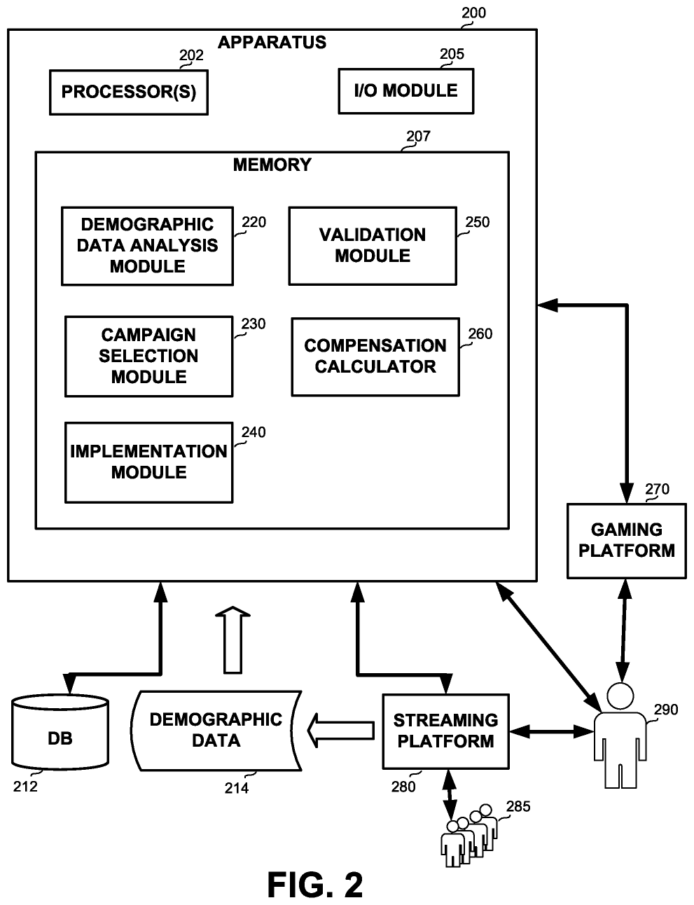

Referring now to FIG. 2 showing a block diagram of an apparatus, in accordance with some exemplary embodiments of the disclosed subject matter. An Apparatus 200 may be configured to support parallel user interaction with a real world physical system and a digital representation thereof, in accordance with the disclosed subject matter.

In some exemplary embodiments, Apparatus 200 may comprise one or more Processor(s) 202. Processor 202 may be a Central Processing Unit (CPU), a microprocessor, an electronic circuit, an Integrated Circuit (IC) or the like. Processor 202 may be utilized to perform computations required by Apparatus 200 or any of its subcomponents.

In some exemplary embodiments of the disclosed subject matter, Apparatus 200 may comprise an Input/Output (I/O) module 205. I/O Module 205 may be utilized to provide an output to and receive input from a user, such as, for example, Content Provider 290, from a Gaming Platform 270, from a Streaming Platform 280, from a Database 212, or the like.

In some exemplary embodiments, Apparatus 200 may comprise Memory 207. Memory 207 may be a hard disk drive, a Flash disk, a Random Access Memory (RAM), a memory chip, or the like. In some exemplary embodiments, Memory 207 may retain program code operative to cause Processor 202 to perform acts associated with any of the subcomponents of Apparatus 200.

Demographic Data Analysis Module 220 may be configured to obtain an estimated aggregated demographic data of an estimated audience of a video. In some exemplary embodiments, the video may be initiated by a Content provider and viewed by a plurality of members. Additionally or alternatively, the video may be streamed via Streaming Platform 280. The estimated audience may comprise a plurality of members expected to watch the video. In some exemplary embodiments, the estimated aggregated demographic data may be determined based on Demographic Data 214 obtained from Streaming Platform 280, from Database 212, or the like.

In some exemplary embodiments, the video may capture Content Provider 290 playing an electronic game, such as by capturing an instance of the electronic game while being played by Content Provider 290, capturing Content Provider 290 herself while playing, a combination thereof, or the like. The electronic game may be configured to be played on Gaming Platform 270. Gaming Platform 270 may be different than Streaming Platform 280.

Campaign Selection Module 230 may be configured to perform a crowd-matching between the estimated audience of the video and a campaign to determine a matched campaign. In some exemplary embodiments, Campaign Selection Module 230 may be configured to select the matched campaign based on a winning bid of an auction, such as an RTB, an offline bid, or the like. Campaign Selection Module 230 may be configured to initiate an auction between a plurality of participating advertisers. Campaign Selection Module 230 may be configured to enable each advertiser to provide a bid for presenting a campaign within the video. Each bid may be based on the estimated aggregated demographic data and defining at least one profile-based compensation. Campaign Selection Module 230 may be configured to compute for each bid of the plurality of participating advertisers an estimated compensation based on the estimated aggregated demographic data. Campaign Selection Module 230 may be configured to compute the estimated compensation based on a number of estimated members having a demographic profile and based on defined profile-based compensation in the bid that corresponds to the demographic profile.

Implementation Module 240 may be configured to provide an instruction to implement the matched campaign within the video. The instruction may be provided to Content Provider 290, to Streaming Platform 280, to Gaming Platform 270, or the like. Additionally or alternatively, the instruction may be provided to an advertising hub (not shown), a party correlating between Content Provider 290, Streaming Platform 280, and Gaming Platform 270, or the like.

In some exemplary embodiments, Implementation Module 240 may be configured to instruct Content Provider 290 may be instructed to perform a certain action related to the campaign, such as holding or viewing an object, to speak about an issue related to the campaign, to say certain phrases, or the like. Implementation Module 240 may be configured to provide an implementation instruction Content Provider 290, at least a predetermined time prior to the video being generated (or at least a predetermined time prior to the campaign being implemented), in order to enabling Content Provider 290 to make preparations for implementing the matched campaign within the video, such as wearing an outfit related to the matched campaign, preparing an item to be presented in the video, preparing a relevant background, or the like. The predetermined time may be about 5 minutes, about 10 minutes, or the like. Additionally or alternatively, the predetermined time may not be above a predetermined threshold, such as about an hour, two hours, a day, or the like, in order to establish an accurate match with the audience.

Additionally or alternatively, Implementation Module 240 may be configured to instruct Gaming Platform 270 to present the matched campaign within the video game, such as by placing an object within the video game played by Content Provider 290, in a location associated with the game instance shown in the video, or the like. Additionally or alternatively, Implementation Module 240 may be configured to instruct Streaming Platform 280 to implement the campaign, such as by automatically placing an item in the vide, adding an effect to the video, or the like.

Validation Module 250 may be configured to automatically validating implementation of the matched campaign in the video. In some exemplary embodiments, Validation Module 250 may be configured to analyzing the video while or after being streamed via Streaming platform 280, to identify a portion of the video in which the campaign is implemented. Additionally or alternatively, Validation Module 250 may be configured to analyzing the video in order to identify an object related to the matched campaign, a subject performing an action related to the matched campaign, or the like.

Additionally or alternatively, Validation Module 250 may be configured to analyze the audience engagement with the matched campaign during providing the video. Validation Module 250 may be configured to analyze a chat service implemented during providing the video to identify statements made in response to the implementation of the matched campaign, such as questions from the crowd about the campaign, comments comprising text related to the campaign, multimedia objects, digital images, sound content, ideograms (e.g., emoji, icons, or the like), or the like utilized by the audience to express a statement in response to the campaign. Additionally or alternatively, Validation Module 250 may be configured to analyze user disconnection during the streaming of the video to identify negative user responses to the implementation of the matched campaign.

Compensation Calculator 260 may be configured to compute a compensation to be provided for the relevant parties, based on the winning bid and based on aggregated demographic data of an actual audience of the video. In some exemplary embodiments, Compensation Calculator 260 may be configured to determine the actual audience of the video, such as based on a data provided by Streaming Platform 280, a data obtained from observing communication related to Streaming Platform 280, based on data provided by Content Provider 290, or the like. Compensation Calculator 260 may be configured to determine aggregated demographic data of the actual audience, such as based on Demographic Data provided by Streaming Platform 280, historical analysis of similar profiles within the audience, such as obtained from Database 212, or the like. Additionally or alternatively, Compensation Calculator 260 may be configured to apply machine learning techniques, location services, or the like, to determine aggregated demographic data of the actual Audience 285.

In some exemplary embodiments, the video with the matched campaign implemented therein, may be streamed or available for streaming, such as in Streaming Platform 280 or other platforms, to different members of Audience 285, simultaneously, or at different times, such as to one subset of Audience 285 about an hour, about a day, or the like, prior to a second subset of Audience 285.

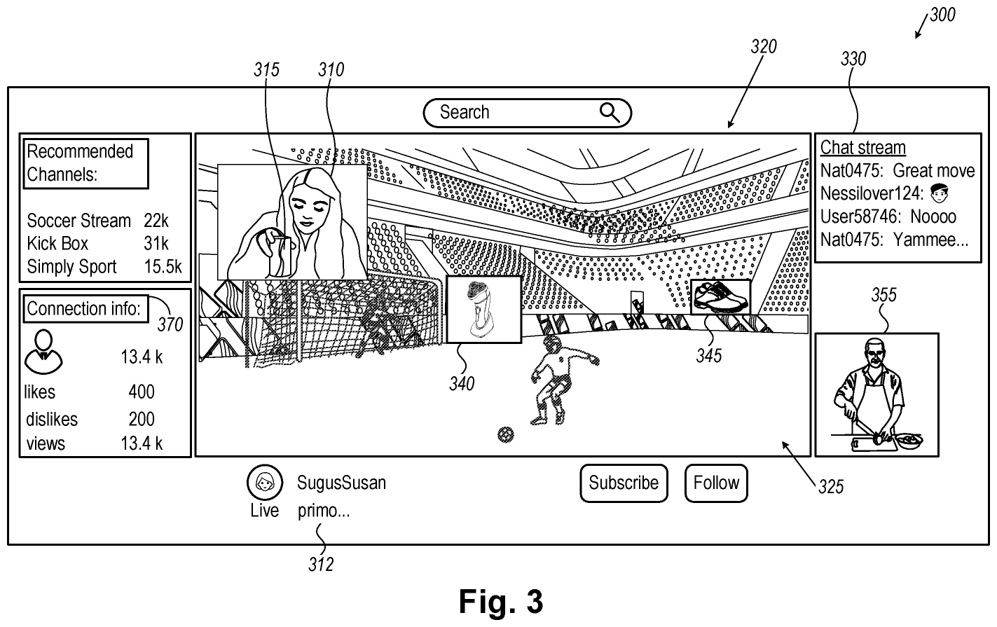

Referring now to FIG. 3 showing a schematic illustration of an exemplary implementation of the disclosed subject matter may be utilized, in accordance with some exemplary embodiments of the disclosed subject matter.

In some exemplary embodiments, a Content Provider 310 may initiate a streaming of a Video 320 in a Streaming Platform 300.

In some exemplary embodiments, Video 320 may be provided to an audience comprising a plurality of members. In some exemplary embodiments, Video 320 may be a live streamed video of Content Provider 310 broadcasting herself playing a football electronic Game 325 to a live audience online. Additionally or alternatively, Video 320 may be streamed to different members of the audience at different times, such as about one hour apart, about few hours apart, or the like. Additionally or alternatively, a copy of Video 320 may be available for the audience to watch for unlimited time after being broadcast, for a limited time, such as one hour, 24 hours, or the like. Each member of the audience may be enabled to watch Video 320 at a different timing.

In some exemplary embodiments, Video 320 may be provided in designated websites or platforms, such as in Twitch™, Huya-Live™, DouYu™, Bilibili™, or the like. Additionally or alternatively, Game 325 may be configured to be played on a designated gaming platform, such as FIFA™, or other platforms. Additionally or alternatively, Game 325 may be configured to be played using a designated device, such as a video game console, a game controller (not shown), using special accessories, such as headsets, virtual reality instruments, or the like. Additionally or alternatively, Game 325 may be a real or an electronic football game not controlled by Content Provider 310.

In some exemplary embodiments, one or more advertising campaigns may be implemented within Video 320. Each of the one or more advertising campaigns may be provided to the audience of Video 320 based on the estimated aggregated demographic data and without performing personalized matching of the campaign to a specific member.

In some exemplary embodiments, the one or more advertising campaigns may be selected automatically based on estimated aggregated demographic data of an estimated audience of Video 320, prior to Video 320 being broadcasted, generated, streamed, or the like. Additionally or alternatively, the one or more advertising campaigns or a portion thereof, may be selected in real time, in response to initiating the streaming of Video 320.

In some exemplary embodiments, an auction between a plurality of participating advertisers may be initiated prior to Video 320 being broadcasted, in response to initiating streaming of Video 320, in response to Content Provider 310 initiating Game 325, in response to a statement provided by Content Provider 310 or other related platform, or the like. Each advertiser of the plurality of participating advertisers may provide a bid for presenting a campaign within Video 320 and based on the estimated aggregated demographic data of an estimated audience of Video 320. Additionally or alternatively, each advertiser of the plurality of participating advertisers may provide a bid for presenting a campaign within Video 320 based on properties of Content Provider 310, such as a number of followers, audience engagement measure, quality of playing, gaming level, or the like. In some exemplary embodiments, such information may be obtained from Streaming Platform 300, based on Profile Data 312 of Content Provider, based on Connection Data 370, or the like. Each advertiser may define one or more profile-based compensations.

In some exemplary embodiments, an estimated compensation may be computed for each bid of the plurality of participating advertisers based on the estimated aggregated demographic data. The estimated compensation may be determined based on a number of estimated members having a demographic profile of each respective profile-based compensation of the one or more profile-based compensations defined in the bid. A winning bid may be selected based on the estimated compensation.

In some exemplary embodiments, in response to selecting a winning bid, an instruction to implement the associated matched campaign within Video 320 may be provided to one or more of Content Provider 310, the streaming platform of Video 320, the gaming platform on charge of Game 325, or the like.

In some exemplary embodiments, an implementation of a first matched campaign may be performed by Content Provider 310, such as by holding Object 315 associated with the campaign (e.g., a branded can of soda). Additionally or alternatively, Content Provider 310 may implement the campaign in another non-formally defined action, such as expressing a good quality of a product (e.g., the drink being tasty), or the like.

In some exemplary embodiments, an instruction to implement the first matched campaign may be provided to Content Provider 310 in a predetermined time prior to Video 320 being generated, to enable Content Provider 310 to make preparations for implementing the matched campaign within Video 320, such as to get Object 315, wear relevant clothes, or the like. The predetermined time may be determined based on the required preparations, a required time for providing Object 315 for Content Provider 310, or the like. As an example, the predetermined time may be about 5 minutes, about 10 minutes, or the like, in case all the preparations are from the side of Content Provider. Additionally or alternatively, Content Provider may be provided with Object 315 in advanced, may utilize similar object that may be automatically replaced, or the like.

Additionally or alternatively, an implementation of a second matched campaign may be performed by the gaming platform within Game 325, such as by placing an Ad 340. It may be noted that other campaigns may be implemented in Game 325 such as Ad 345 that may be implemented in Game 325 independently from Ad 340, may be targeted to Content Provider 310, or the like. Additionally or alternatively, the one or more advertising campaigns, including the second matched campaign implemented as Ad 340, may be selected based on knowledge that Game 325 is being watched by other people than Content Provider 310. In some exemplary embodiments, an instruction to implement the second matched campaign may be provided to the gaming platform in a predetermined time prior to Game 325 being played, to enable the gaming platform to implementing the second matched campaign within Game 325. Additionally or alternatively, the instruction may be provided in real time, such that the implementation may be performed automatically.

Additionally or alternatively, an implementation of a second matched campaign may be performed by the gaming platform within Game 325, such as by placing an Ad 340. It may be noted that other campaigns may be implemented in Game 325 such as Ad 345 that may be implemented in Game 325 independently from Ad 340, may be targeted to Content Provider 310, or the like. Additionally or alternatively, Ad 345 may be an implementation of a third matched campaign targeted to another profile, or the like. Additionally or alternatively, the one or more advertising campaigns, including the second matched campaign implemented as Ad 340) may be selected based on knowledge that Game 325 is being watched by other people than Content Provider 310. Additionally or alternatively, an implementation of a fourth matched campaign may be performed by the streaming platform, within or adjacent to Video 320, such as placing an Ad 350 below Video 320, placing a popping Ad 355 over Video 320, or the like.

In some exemplary embodiments, an instruction to implement the second matched campaign may be provided to the gaming platform in a predetermined time prior to Game 325 being played, to enable the gaming platform to implement the second matched campaign within Game 325. Additionally or alternatively, the instruction may be provided in real time, such that the implementation may be performed automatically.

In some exemplary embodiments, the first, the second, the third and the fourth matched campaigns may be selected in different independent auctions, in the same auction, in related auctions, or the like. The first, the second, the third and the fourth matched campaigns may be provided by different advertisers. Additionally or alternatively, the first, the second, the third and the fourth matched campaigns may target different demographic profiles. As an example, the second campaign implemented using Ad 345 may be targeted to male members, above 45 years old; while the first campaign implemented by Content Provider 310 using Object 315 may be targeted to members located in Asia.

In some exemplary embodiments, an automatic validation of implementation of the matched campaigns in Video 325 may be performed. In some cases, the validation may be performed automatically, such as using image analysis techniques, or other automatic tools, that may be configured to identify pixels within Video 325 related to the matched campaign, searching for predefined markers or objects, or the like. Additionally or alternatively, Video 325 may be analyzed to identify a portion of thereof in which the matched campaign is implemented, such as a physical location within Video 325 in which the campaign is implements, the timing in which the campaign is implemented, or the like. Additionally or alternatively, the portion of the video in which Content Provider 310 performs the non-formally defined action may be identified.

In some exemplary embodiments, the audience may be enabled to provide feedback to Video 320, Game 325, or the like, such as using a chat service as viewed in Chat Box 330, a designated communication service associated with Game 325, such as expressing an interaction with Game 325, generating a visual feedback, a graphic display, or the like, into Game 325, using a designated input device such as a joystick, a controller, a motion sensing device, or the like. The interaction or the visual feedback may be shown on Video 320 within Game 325, outside Game 325, in a separated window, or the like. Additionally or alternatively, the interaction may comprise audio feedback delivered through speakers or headphones, and presented in Video 320 through Game 325. The automatic validation may comprise analysis of audience engagement with the matched campaign during providing Video 320. Such analysis may be performed based on an analysis of Chat Box 330 to identify statements made in response to the implementation of the matched campaign. Additionally or alternatively, the analysis may be analyzing user disconnection during the streaming of Video 320 to identify negative user responses to the implementation of the matched campaign, such as by analysis of Connection Info 370, or the like.

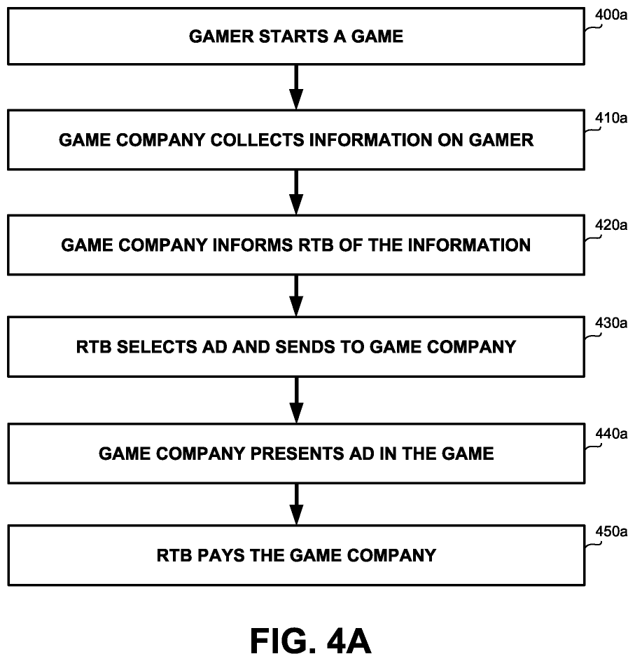

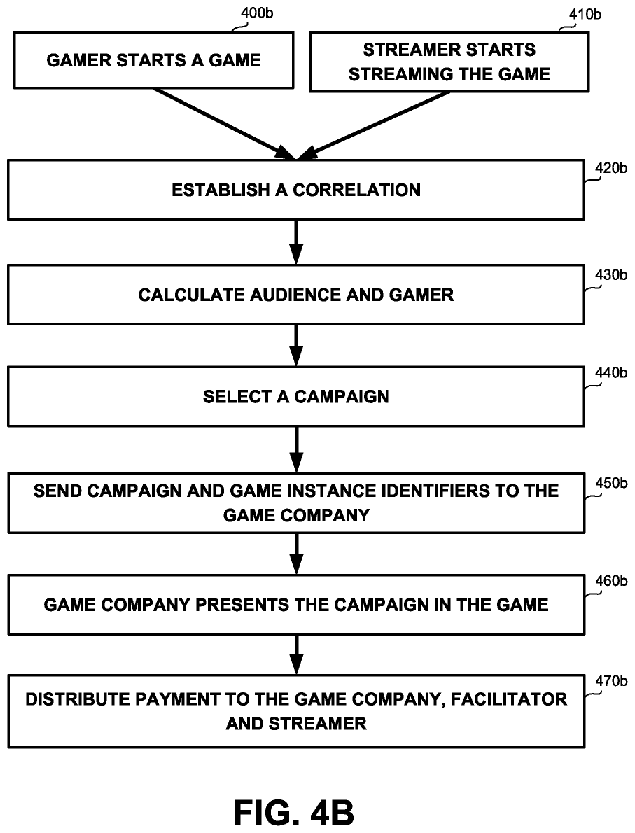

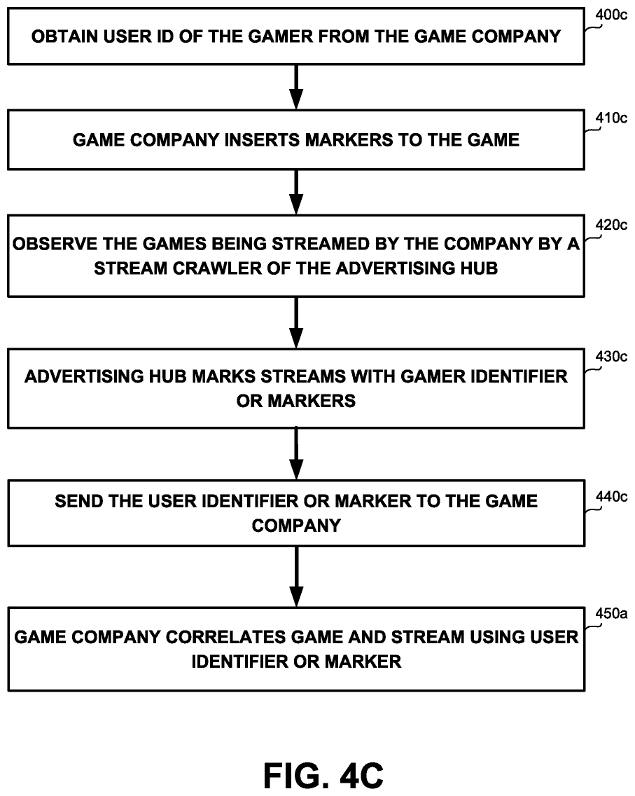

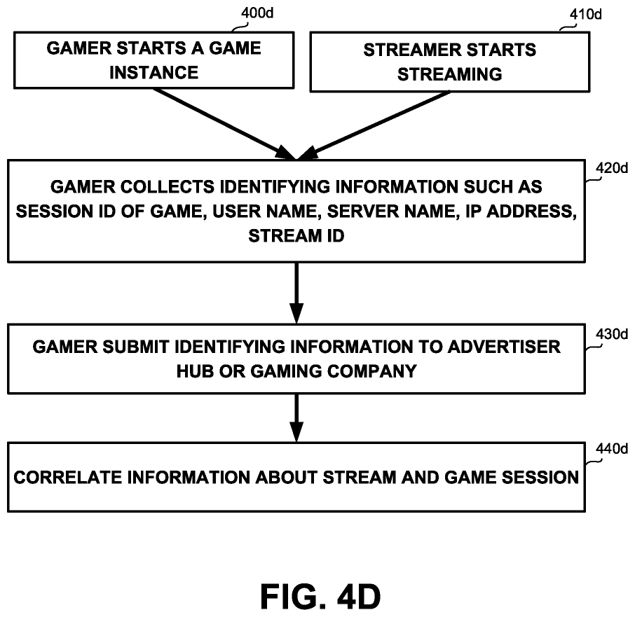

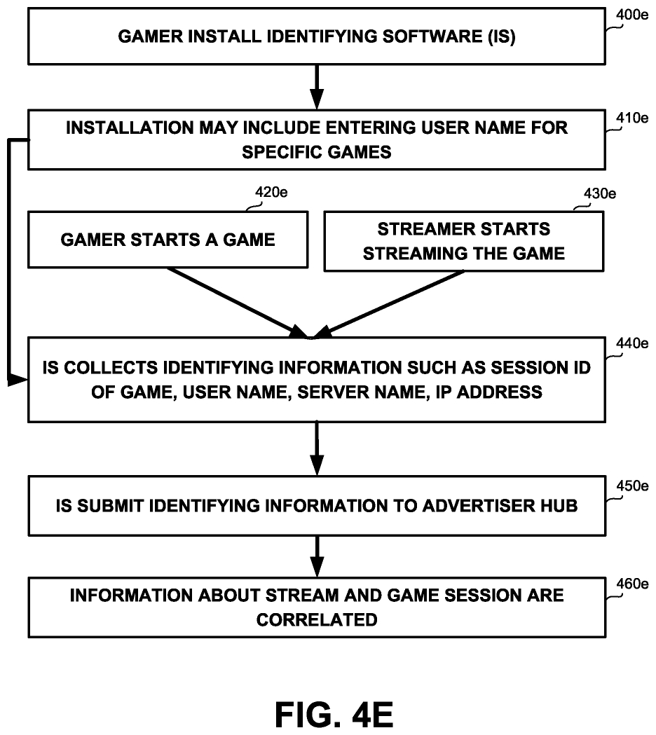

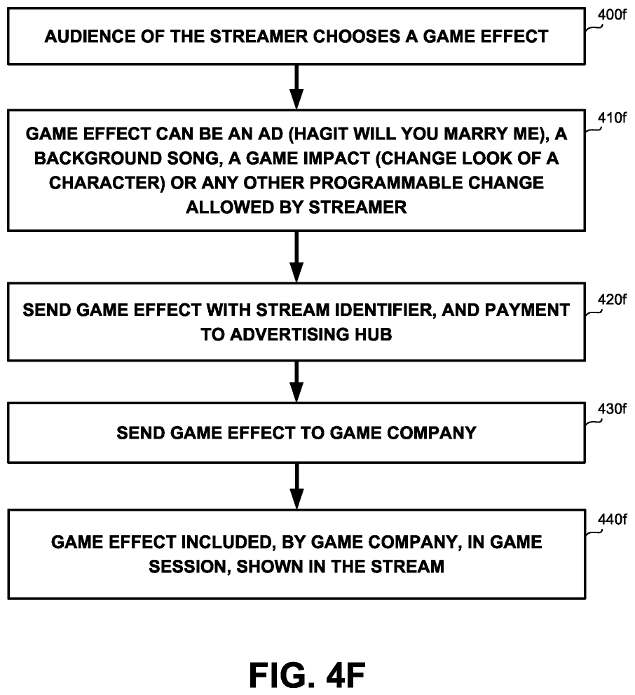

Referring now to FIG. 4A showing a flowchart diagram of a method, in accordance with some exemplary embodiments of the disclosed subject matter.

On step 400a, a gamer starts a game instance. In some exemplary embodiments, the gamer may be playing the game on her device. The device may be a gaming machine, a computer, a lap-top, a phone or any device connected to the net. The game may be played over the net.

On step 410a, the gaming company may collect any information it knows about the gamer. The information may be related to how many hours the gamer plays and when, geographical location of the gamer, identification data of the gamer, playing habits of the gamer (such as attributes of how the gamer plays the game (e.g., aggressiveness, smart, or the like)), scores, or the like. Additionally or alternatively, the information may comprise information about interaction of the gamer with in game advertisement in the past. Additionally or alternatively, the information may include any information that was collected during registration. If the game is a multi-player game it may collect any information on the interaction with other players, such as language in chats, geo of others, etc.

On steps 420a and 430a, a campaign (also referred to as an advertisement) may be selected. In some exemplary embodiments, the game company may inform the RTB of the information on the player, and the RTB may select and advertisement and sends the advertisement to the game company. In some exemplary embodiments, the RTB functionality may be internal to the game company in which case the internal RTB chooses the advertisement to be displayed to the gamer.

On step 440a, the gaming company may present the campaign selected in step 430a organically within the game. This means the advertisement may be presented as a part of the game, either in a game advertising board, or presented on any object in the game (on a car or a building or grass of a sports event for example.).

On step 450a, some amount is paid by the advertisers for the advertisement being displayed. The amount may be split between the RTB and the game company, or if the game company is also the RTB all of it goes to the game company. If the game enables in game action, for example upon watching the advertisement in the game for a coke the gamer buys a coke, or upon advertisement of Pizza in the game, the gamer orders a pizza, or use a coupon of the specific advertisement, the payment may depend on the advertisement displayed, on the action taken or on both.

Referring now to FIG. 4B showing a flowchart diagram of a method, in accordance with some exemplary embodiments of the disclosed subject matter.

On step 400b, a gamer starts a game instance. In some exemplary embodiments, the gamer is playing the game on his device. The device can be a gaming machine, a computer, a lap-top, a phone or any device connected to the net. The game may be played over the net.

On step 410b, a streamer starts a streaming instance in which the game instance is streamed. In some embodiment the gamer is playing the game on his device. The device can be a gaming machine, a computer, a lap-top, a phone or any device connected to the net. The game is played over the net. In some embodiment the stream contains a video of the game played as it is being played, as well as a video of the player playing the game. In that second video included in the stream we may be able to see the gamer/streamer or hear him or both. The stream may also contain a portion dedicated to interaction with the audience watching the stream. The streamer may type in that portion, or talk, or act, in reaction to the audience. The order between steps 100 and 110 is arbitrary and it may be that the game instance starts first or that the streaming instance starts first. The game may be streamed on part of the streaming instance or on the whole of it.

On step 420b, a correlation between the game instance and streaming instance may be established. In FIGS. 4C-4E different methods for establishing such correlation are detailed. As an example, FIG. 4C shows a flowchart diagram of a method for correlating game instance and stream instance without any help of the streamer/gamer and no software on the gamer computer. As another example, FIG. 4D shows a flowchart diagram of s method for correlating game instance and stream instance using the help of the streamer/gamer. As yet another example, FIG. 4E shows a flowchart diagram of a method for correlating game instance and stream instance using identifying software on the streamer/gamer computer.

On step 430b, properties of the audience and the streamer and the stream that are important for the task of advertisement selection may be calculated. Step 410a of FIG. 4A, explains how the game company may collect information on the player playing a specific game instance. Properties of the streamer as a streamer may be collected based on his biography, IP address, and previous streams. Properties of the stream (content, child appropriate, etc.,) may be collected based on the tags on the stream, previous streams, audience interaction in the stream and in previous stream. Current audience and expected current audience properties may be calculated based on data collected from the streaming platform, the gaming company, or the like.

On Step 440b, an advertisement (campaign) that is a good fit for the streamer, the audience and the stream may be selected. The selection may be performed based on the data collected in step 430b.

In some exemplary embodiments, on Steps 450b and 460b, the advertisement and the game instance may be sent by the advertising hub, in the correct format, to the game company. The game company may embed the advertisement in the game instance so that the gamer and the audience see it. In some exemplary embodiments, the game company may be the one that decide on the advertisement, and embed the selected advertisement thereby in the game instance. In both cases, the game company may be informed of the relevant game instance, and the advertisement that has to be embedded in it, and may embed the advertisement in that game instance.

On Step 570b, a payment for the advertisement may be distributed. In some exemplary embodiments, the advertisement hub that sends the advertisement to the game company, may be configured to calculate the payment. The payment may be aggregated for multiple advertisements but the aggregation may contain specific payment for each advertisement. The payment may be a percentage of the payment to be paid by the publisher for the advertisement. The payment may depend upon properties of the audience, for example number of people watching and other characteristics (e.g., demographics, interests) of viewers, and not only the gamer. In some exemplary embodiments, the advertisement may be selected by the game company itself and the payment may be issued to the game company from the publisher. The amount of payment depends on properties of the audience and therefore knowing information about the audience, and that there is an audience, impacts the size of the payment for a given advertisement.

Referring now to FIG. 4C showing a flowchart diagram of a method, in accordance with some exemplary embodiments of the disclosed subject matter.

On Step 400c and 410c, the game company may define or create markers in game instances that for observers of the game instance, with the right software, may make the game instance unique. Markers may comprise user name in the game, and where it is in the game screen. Additionally or alternatively, the markers may comprise barcodes in some location in the game, audible marks, visual marks, or the like. The markers may be required to be unique only among the current game instances. As an example, if there are 2000 currently playing, 2000 game instances, we need just 2000 unique markers. Some markers may be integral part of the game instance, such as user name, or maybe game instance ID if one is visible. Other markers, such as the barcoded or the audible marker using steganography, may be required to be inserted to the game. The property may be that with the right software, when observing the game being played, as in observing the screen or listening to the game, the unique markers can be detected.

On step 420c, a crawler may crawl over the games being streamed by streaming application. In some exemplary embodiments, the crawler may belong to the advertising hub. The crawler may observe the streams and detect the unique markers. In some exemplary embodiments, the unique marker may be user ID, or a number in a bar code, or the like.

On Step 430c, the stream instance may be annotated in some database with the unique marker found in Step 420c.

On Step 440c, the unique marker may be sent to the game company, with the stream instance. The game company can now correlate between the game instance and the stream instance (Step 450c). Additionally or alternatively, the advertising hub may now be aware of the game instance that correlates with the streaming instance. In such embodiments, the correlation may be performed by the advertising hub which sends the advertisements to the game company and tells the game company in which game instance to publish them using the unique marker found in step 420c. Additionally or alternatively, the game company may be on charge of crawling the streaming instances, looking for its own generated markers, or the like. Once the marker is found, the game company may perform the correlation between the game instance and the streaming instance.

Referring now to FIG. 4D showing a flowchart diagram of a method, in accordance with some exemplary embodiments of the disclosed subject matter.

On Step 400d, the gamer starts a game on his platform. The platform can be computer, gaming machine, phone or any other machine.

On Step 410d, the gamer start streaming. It may be noted that Steps 400d and 410d can be performed in any order. As an example, the stream may be started before starting the game, or vice versa.

On Step 420d, the gamer collects information that may be used to correlate the game instance with the stream instance. It can his user id in the game, the time he started the game, the IP address, the stream instance ID, the name of the game server, or any other such information. He also collects the streaming ID in which he live streams, or will live stream soon, the game he is playing. The information may include his user on the streaming platform, optionally a different user ID from the user in the gaming platform.

On Step 430d, the gamer/streamer send the information she collected to either the advertisement hub or the game company or the streaming company.

On Step 440d, the two instances, that of the game and of the stream are correlated.

Referring now to FIG. 4E showing a flowchart diagram of a method, in accordance with some exemplary embodiments of the disclosed subject matter.

On Step 400e and 410e, the gamer/streamer may install identifying software on his gaming platform, such as on his laptop, gaming machine, phone, computer, or the like. This include both installing the software but also inserting information that can be used for correlation. For example, in the software he may write the username that he uses to login to the game, or his name when he plays that other players can see, or any other information that the gaming company can used to correlate. The information may comprise his user ID on the streaming platform, a different user ID from the user in the gaming platform, or the like.

It may be noted that one goal of the identifying software is to reduce the manual work done by the streamer/gamer to enable correlation between the game instance and stream instance. Once the software is installed it will do this work automatically instead of the streamer/gamer. Semi-automatic options in which the software is activated manually are also envisioned. In the fully automatic version, the software identifies that the stream and the game instance are started. In the seme-automatic, the user activates the software at the needed time.

On Step 420e, the gamer starts playing the game.

On Step 430e, the gamer starts streaming. It may be noted that the order between steps 420e and 430e may be any order, and streaming can start before playing or vice versa.

On Step 440e, the identifying software, may automatically collects information. The information may comprise the starting time of the game, the session ID of the game, the machine IP, the server's name or any other identifying characteristics. The identifying software may record the stream instance identifier.

On Step 450e, the identifying software may transmit all the information it collected and that was recorded initially by the game and the streamer to the entity that will do the correlation. The correlation may be performed by the advertising hub, the gaming company, a combination thereof, or the like. Additionally or alternatively, the streaming company may be also the advertising hub, the gaming company may be also the advertising hub, or the like.

On Step 460e, the entity that received the information from the identifying software may correlate between the game instance and the streaming instance.

Referring now to FIG. 4F showing a flowchart diagram of a method, in accordance with some exemplary embodiments of the disclosed subject matter.

In some exemplary embodiments, a person in the audience of a streamer that streams a game instance, may be enabled to impact the game instance with an advertisement or some other effects.

In some exemplary embodiments, the audience may be enabled to create an in-game advertisement or effect, during streaming of the game. In some exemplary embodiments, the advertisement may be selected by the game company, the advertising hub, or the like. This has somewhat similar motivation to a person choosing a song with a song machine in a restaurant so that all in the restaurant, all the people present including him, are listening to his song, but the technology may be very different.

On Steps 400f and 410f, a member of the audience may decide to choose an advertisement that will be shown in the game, or a game effect, such as for instance a background song, or any other effect possible for gamers to choose that is allowed to audience, such as color of house, the choice of enemy, or any other effect.

On Step 420f, the member sends his selection to the advertising hub or the game company. In some exemplary embodiments, the submission may be performed by sending, using additional information channel such as instance messaging, or email, or phone or any other additional channel, the request and the stream instance ID to the advertising hub to be forwarded to the game company or to the game company directly. Additionally or alternatively, the request may be written in the chat portion of the stream. In some exemplary embodiments, the crawler which is observing the stream, finds the requests. Additionally or alternatively, a software by the streamer, or by the audience, identifies the request and process it. In some exemplary embodiments, the streaming company may be willing to accept instructions in the chat portion of the stream and the instructions are written using this language. In some exemplary embodiments, an add-on to the streaming software may be configured to identify such requests.

On Step 430f, the request may be forwarded to the game company. The request may comprise the game instance and the requested game effect or advertisement.

On Step 440f, the game company may implement the game effect on the game instance. That means that all the audience can now observe the game effect requested by one member of that audience.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining an estimated aggregated demographic data of an estimated audience of a video, wherein the estimated audience comprises a plurality of members, wherein the video is configured to be provided to the plurality of members;
performing a crowd-matching between the estimated audience of the video and a campaign to determine a matched campaign, wherein said performing crowd-matching comprises:
initiating an auction between a plurality of participating advertisers, wherein each advertiser of the plurality of participating advertisers providing a bid for presenting a campaign within the video, wherein the bid is based on the estimated aggregated demographic data and defining at least one profile-based compensation;
computing for each bid of the plurality of participating advertisers an estimated compensation based on the estimated aggregated demographic data, wherein the estimated compensation is determined based on a number of estimated members having a demographic profile and based on defined profile-based compensation in the each bid that corresponds to the demographic profile; and
selecting a winning bid for the auction based on the estimated compensation; and
providing an instruction to implement the matched campaign within the video,
whereby the matched campaign is provided to an audience of the video based on the estimated aggregated demographic data and without performing personalized matching of the matched campaign to a specific member.

2. The method of claim 1, wherein the winning bid defining a profile-based compensation for a targeted demographic profile and not defining a profile-based compensation for a non-targeted demographic profile, wherein the estimated compensation is determined based on an estimated number of members in the estimated audience having the targeted demographic profile, wherein the determination of the estimated compensation is indifferent to a number of members in the estimated audience having the non-targeted demographic profile.

3. The method of claim 2, wherein the winning bid defining a profile-based compensation for a second targeted demographic profile different than the profile-based compensation for the targeted demographic profile, wherein the estimated compensation is determined as C=n₁c₁+n₂c₂, wherein C denotes the estimated compensation, n₁ denotes an amount of members in the estimated audience having the targeted demographic profile, n₂ denotes an amount of members in the estimated audience having the second targeted demographic profile, c₁ denotes the profile-based compensation for the targeted demographic profile, c₂ denotes the profile-based compensation for the second targeted demographic profile.

4. The method of claim 2, wherein the participating advertisers comprise a first advertiser and a second advertiser, wherein the first advertiser providing the winning bid, wherein the second advertiser providing a second bid, wherein the second bid defining a profile-based compensation for the non-targeted demographic profile.

5. The method of claim 1 further comprises: automatically validating implementation of the matched campaign in the video.

6. The method of claim 5, wherein said automatically validating implementation of the matched campaign in the video comprises: analyzing the video to identify a portion of the video in which the matched campaign is implemented.

7. The method of claim 6, wherein the matched campaign is implemented by a subject appearing in the video performing a non-formally defined action, wherein said analyzing the video comprises identifying the portion of the video in which the subject performs the non-formally defined action.

8. The method of claim 5, wherein said automatically validating comprises analyzing audience engagement with the matched campaign during providing the video.

9. The method of claim 8, wherein said analyzing the audience engagement comprises at least one of:
analyzing a chat service implemented during providing the video to identify statements made in response to the implementation of the matched campaign; and
analyzing user disconnection during the streaming of the video to identify negative user responses to the implementation of the matched campaign.

10. The method of claim 1 further comprising:
determining an actual audience of the video;
determining aggregated demographic data of the actual audience;
computing a compensation based on the winning bid and based on the aggregated demographic data of the actual audience; and
providing the computed compensation.

11. The method of claim 1, wherein a content provider initiating the streaming of the video, wherein the video captures the content provider playing an electronic game, wherein said implementing the matched campaign comprises instructing the electronic game to present the matched campaign.

12. The method of claim 11, wherein the electronic game is configured in an absence of said instructing to provide a campaign targeting the content provider.

13. The method of claim 11, wherein the video is streamed by the content provider to the audience via a streaming platform, wherein the electronic game is configured to be played on a gaming platform, wherein the streaming platform and the gaming platform are different.

14. The method of claim 1, wherein the instruction is provided to a content provider of the video in a predetermined time prior to the video being generated, whereby enabling the content provider to make preparations for implementing the matched campaign within the video.

15. The method of claim 1, wherein the audience of the video comprises a first and a second members, wherein the video is streamed to the first member at least one hour before the second member, whereby the matched campaign is provided to the first and the second members at different times.

16. A computerized apparatus having a processor, the processor being adapted to perform the steps of:
obtaining an estimated aggregated demographic data of an estimated audience of a video, wherein the estimated audience comprises a plurality of members, wherein the video is configured to be provided to the plurality of members;
performing a crowd-matching between the estimated audience of the video and a campaign to determine a matched campaign, wherein said performing crowd-matching comprises:
initiating an auction between a plurality of participating advertisers, wherein each advertiser of the plurality of participating advertisers providing a bid for presenting a campaign within the video, wherein the bid is based on the estimated aggregated demographic data and defining at least one profile-based compensation;
computing for each bid of the plurality of participating advertisers an estimated compensation based on the estimated aggregated demographic data, wherein the estimated compensation is determined based on a number of estimated members having a demographic profile and based on defined profile-based compensation in the each bid that corresponds to the demographic profile; and
selecting a winning bid for the auction based on the estimated compensation; and
providing an instruction to implement the matched campaign within the video,
whereby the matched campaign is provided to an audience of the video based on the estimated aggregated demographic data and without performing personalized matching of the matched campaign to a specific member.

17. A computer program product comprising a non-transitory computer readable storage medium retaining program instructions, which program instructions when read by a processor, cause the processor to perform a method comprising:
obtaining an estimated aggregated demographic data of an estimated audience of a video, wherein the estimated audience comprises a plurality of members, wherein the video is configured to be provided to the plurality of members;
performing a crowd-matching between the estimated audience of the video and a campaign to determine a matched campaign, wherein said performing crowd-matching comprises:
initiating an auction between a plurality of participating advertisers, wherein each advertiser of the plurality of participating advertisers providing a bid for presenting a campaign within the video, wherein the bid is based on the estimated aggregated demographic data and defining at least one profile-based compensation;
computing for each bid of the plurality of participating advertisers an estimated compensation based on the estimated aggregated demographic data, wherein the estimated compensation is determined based on a number of estimated members having a demographic profile and based on defined profile-based compensation in the each bid that corresponds to the demographic profile; and
selecting a winning bid for the auction based on the estimated compensation; and
providing an instruction to implement the matched campaign within the video,
whereby the matched campaign is provided to an audience of the video based on the estimated aggregated demographic data and without performing personalized matching of the matched campaign to a specific member.
